(19) United States
(12) Patent Application Publication
(10) Pub. No.: US 2012/0256727 A1
(43) Pub. Date: Oct. 11, 2012

(54) SELECTIVELY ENABLED RFID TAG

(75) Inventor: Gary L. Moore, JR., Dayton, OH (US)

(73) Assignee: REDBUD SYSTEMS, LLC, Dayton, OH (US)

(21) Appl. No.: 13/081,980

(22) Filed: Apr. 7, 2011

(51) Int. Cl. G06K 7/01; G06K 19/077

(52) U.S. Cl. 340/10.1; 235/492

(57) ABSTRACT

A RFID tag including an outer casing, an antenna positioned in the outer casing, and a chip positioned in the outer casing. At least one of the chip or the antenna is manually movable into or out of electrical communication with the other one of the chip or antenna.

The present invention is directed to an RFID tag, and more particularly, to a selectively enabled RFID tag.

### BACKGROUND

RFID tags are used to transmit information, data or the like when exposed to an appropriate wavelength and/or frequency of electromagnetic radiation. RFID tags are becoming increasingly more ubiquitous and are incorporated in a wide variety of cards, devices and the like, and tags may be used to store confidential and/or personal information. Accordingly, when a RFID tag passes within the range of an RFID reader, the RFID reader may be able to extract personal and/or confidential information from the RFID tag without the consent of the RFID tag owner.

### SUMMARY

In one embodiment, the present invention is an RFID tag which is selectively enabled to minimize the loss of personal, confidential or other information. In particular, in one embodiment the invention is a RFID tag including an outer casing, an antenna positioned in the outer casing, and a chip positioned in the outer casing. At least one of the chip or the antenna is manually movable into or out of electrical communication with the other one of the chip or antenna.

In another embodiment, the invention is a RFID tag including an antenna and a generally flat, planar chip. At least one of the chip or antenna is biased to a disabled position in which the chip and antenna are not in electrical contact, or an enabled position in which the chip and antenna are in electrical contact. The at least one of the tag or the antenna is manually movable from the biased position to the other position, and wherein the distance the at least one of the chip or antenna moves between the positions is less than a dimension of the chip with a plane of the chip.

### BRIEF DESCRIPTION OF DRAWINGS

FIG. 1 is a top schematic view of one embodiment of the RFID tag of the present invention;

FIG. 2 is a schematic cross-section of the RFID tag of FIG. 1, with the chip and antenna out of electrical contact;

FIG. 3 illustrates the RFID tag of FIG. 2, with the chip and antenna in electrical contact;

FIG. 4 is a top perspective view of the RFID tag of FIG. 1, with various portions of certain layers of the RFID tag cut away;

FIG. 5 is a top view of an alternate embodiment of the RFID tag of the present invention; and

FIG. 6 is a schematic cross section of the tag of FIG. 6, with the chips and antenna out of electrical contact.

### DETAILED DESCRIPTION

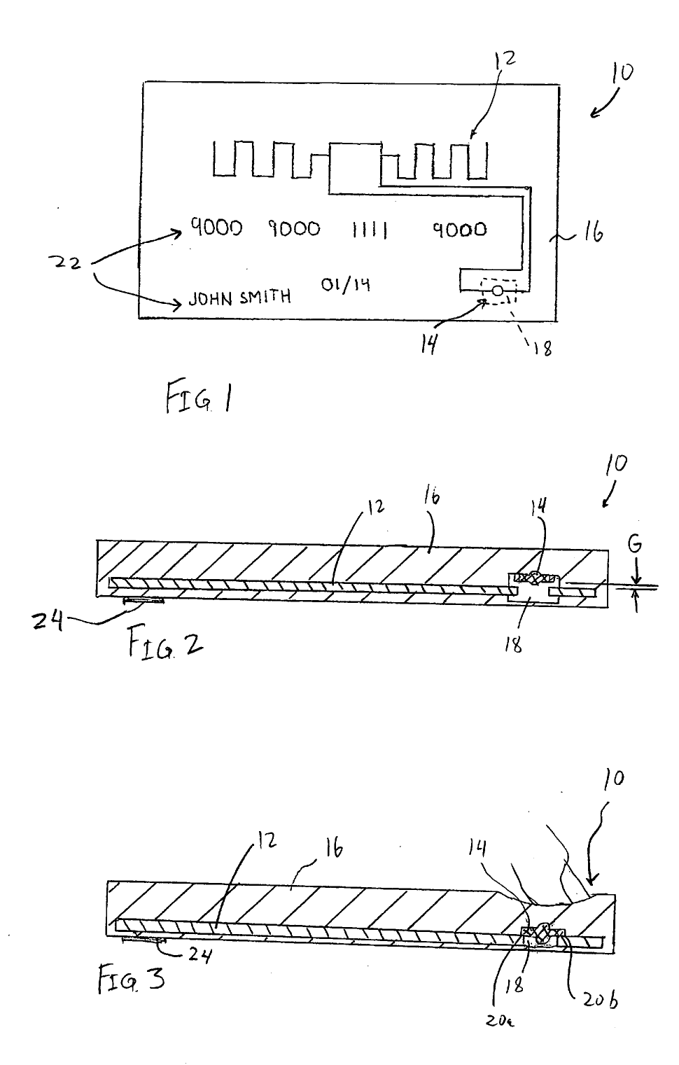

FIGS. 1-4 illustrate a first embodiment of the RFID tag 10 of the present invention. The illustrated RFID tag 10 includes an antenna 12 which is tuned to a specific frequency and/or wavelength of electromagnetic radiation. The RFID tag 10 further includes a chip 14 which can take the form of a microchip, an integrated circuit, CMOS circuitry, or other logic circuitry or the like. The RFID tag 10 further includes an enclosure, laminate or outer casing 16.

In the illustrated embodiment, both the antenna 12 and chip 14 are substantially embedded in, and carried within, the outer casing 16 which forms the majority of the volume of the RFID tag 10. The outer casing 16, in the illustrated embodiment, also forms the outer surfaces of the RFID tag 10 to seal and protect the antenna 12 and chip 14. The outer casing 16 may be generally continuous, particularly across its outer surfaces, to protect the internal components. The casing 16 can be made of a wide variety of materials such as, for example, polyvinyl chloride acetate, although the casing 16 can be made of a wide variety of plastic, polymer or other suitably protective and flexible materials. The casing 16 can be made of translucent, transparent and/or opaque materials, as desired. However, in the embodiment of FIG. 1, the casing 16 is illustrated as being transparent for illustrative purposes.

In the illustrated embodiment, both the antenna 12 and the chip 14 are generally flat and planar, and are positioned out-of-plane in the configuration shown in FIG. 2. In addition, in the illustrated embodiment, a void 18 is positioned in the casing 16, and located at or adjacent to the chip 14. For example, in the embodiment shown in FIG. 2, the void 18 is positioned below the chip 14, and extends downwardly to (and slightly below) the plane of the antenna 12. However, the void 18 can be positioned in any wide variety of locations within the tag 10/casing 16, including above the chip 14, between the chip 14 and the antenna 12, below the chip 14, and combinations thereof.

In the state shown in FIG. 2, the chip 14 is biased out-of-plane, and therefore out of electrical contact, with the antenna 12. Thus, in FIG. 2 the RFID tag 10 is in its disabled state or condition and cannot be operated as an RFID tag or device. When it is desired to enable the tag 10 for RFID operation, portions of the RFID tag 10 positioned above/below the void 18 are manually pressed and deformed, as shown in FIG. 3. In this manner, when the user manually presses on the appropriate location of the card 10, the void 18 and outer casing 16 are elastically deformed and the chip 14 is pressed into contact with the antenna 12, thereby moving the tag 10 to its enabled position or state. In one embodiment, the appropriate surface (i.e. top surface in the illustrated embodiment, in the area of the chip 14/void 18 shown in FIG. 1) of the outer casing 16 may include indicia indicating where a user is to press to enable the card (i.e. a symbol, or text such as “press here to enable,” etc.).

When the RFID tag 10 is enabled, the RFID tag 10 may be exposed to electromagnetic radiation, such as that emitted by a RFID reader. The electromagnetic radiation may be at or substantially at the particular frequency/wavelength to which the antenna 12 is tuned. The antenna 12 collects energy from the electromagnetic waves to induce a charge therein, which is in turn communicated to the chip 14. Once the chip 14 receives a sufficient charge (and in some cases, after an appropriate time delay, such as about 0.5 seconds in one case), the chip 14 generates a data pulse that includes data or information, such as alphanumeric data, and in some cases alphanumeric data corresponding to a unique identifier of the chip 14. The data pulse is then provided to the antenna 12, which uses the energy provided from the chip 14 (or previously stored in the antenna 12) to broadcast the data associated with the chip 14 back outward such that it can be, for example, received by the RFID reader. In this manner, when enabled, the RFID tag 10 can respond to output from an RFID reader in a standard manner for RFID tags/devices.

When it is desired to disable the tag 10, the user removes his or her finger from the tag 10/casing 16, thereby removing the manual pressure. The tag 10/casing 16 then elastically returns to its original, undeformed disabled state, as shown in FIG. 2. In this manner, a user can control when the tag 10 is enabled and capable of emitting a signal, and when a tag 10 is disabled, thereby providing increased security and control.

As noted as noted above, in the illustrated embodiment the chip 14 is positioned out-of-plane with the antenna 12 when the chip 14 is in its disabled position. Thus, as can be seen in FIG. 2, the tag 10 has a gap G extending in a direction of perpendicular to the plane of the chip 14/antenna 12/tag 10 when the tag 10 is in its disabled position, the gap G extending in the direction of travel of the chip 14. The gap G should be sufficiently large to ensure the RFID tag 10 can be effectively disabled and the antenna 12 and chip 14 moved out of effective electrical contact/communication. In contrast, when the chip 14 is pressed into contact with the antenna 12, the chip 14 makes two spaced points of contact 20a, 20b with the antenna 12 (FIG. 3). Accordingly, under this arrangement, the chip 14 makes two spread points of contact 209, 206 when enabled, and provides two separate and discrete open circuits when disabled, which helps to ensure the tag 10 is not accidentally enabled when it is desired to be disabled (and vice versa).

As noted above, the void 18/gap G should be large enough to ensure that the chip 14 remains decoupled from the antenna 12 when desired. However, the void 18/gap G should be sufficiently small that the casing 16 can be deformed without requiring undue manual pressure, and so the chip 14 can repeatedly accurately engage the antenna 12. In addition, in the illustrated embodiment, the chip 14 is positioned immediately above the antenna 12/void 18 such that the chip 14 is moved translationally (i.e. as opposed to pivotally) when the chip 14 is moved into its enabled position to more easily accommodate typical manual pressure. The antenna 12/void 18/chip 14 may also need to be precisely shaped and positioned to ensure proper contact is made when desired.

As can be seen in FIG. 4, the chip 14 may be generally flat and planar within the chip plane and have a length l and a width w within the chip plane. The size of the gap G is, in one case, less than either the width w or length l of the chip 14 such that the chip 14 is required to move a relatively small distance between the enabled and disabled position. In one particular case, the gap G is less than about ⅛″, and in another embodiment is less than about 1/16″.

The configuration disclosed herein, in which the chip 14 is out of plane with the antenna 12, and moved into contact with the antenna 12 (or vice versa) also provides certain manufacturing advantages. In particular, a plurality of partially completed RFID tags 10 can be manufactured with a particular type of antenna 12, and a plurality of chips 14 can be separately manufactured and/or stored. When it is desired to complete the RFID tag 10, a chip is 14 selected and mated with an antenna 12 to form a tag 10. The separate manufacturing and storage of antennae 12 and chips 14, and their ability to be joined together at the time of manufacture, enables modular manufacturing for greater efficiency and flexibility.

FIG. 4 illustrates one embodiment of the tag 10, with portions of various layers thereof cut-away to show the various sub-layers, and which includes the antenna plane 26, chip plane 28, and upper plane 30, each of which has portions cut-away for illustrative purposes. In the embodiment of FIG. 4 (in contrast to FIGS. 2 and 3), the chip 14 is positioned below the antenna 12. In this case, the antenna 12 (or at least parts of the antenna 12 positioned adjacent to the chip 14) may be deflectable out-of-plane and into contact with the chip 14 to electrically couple the antenna 12 and chip 14. In actuality, in both the embodiment of FIGS. 2 and 3 (wherein the chip 14 is positioned above the antenna 12) and the embodiment of FIG. 4 (wherein the chip 14 is positioned below the antenna 12), both the chip 14 and antenna 12 may be deflected somewhat out-of-plane upon the application of manual pressure.

In some cases, however, it may be desired to limit the deflection of the antenna 12, as excessive deflection of the antenna 12 could adversely effect its reception/broadcast properties and capabilities. The embodiments disclosed herein in which the chip 14, and/or portions of the antenna 12 positioned adjacent to the chip 12, are deflected (as opposed to, for example, deflection of larger portions of the antenna) helps to limit deflection of the antennas 12 and ensure proper operation thereof.

In addition, the embodiments shown in FIGS. 1-4 show the RFID tag 10 being biased into a position in which the chip 14 and antenna 12 are electrically decoupled. However, the biasing state of the RFID tag 10 can be reversed. In particular, the chip 14 and antenna 12 can be biased into electrical contact, in which case manual pressure can be utilized to move the chip 14 and antenna 12 out of electrical contact to disable the RFID tag 10.

As shown in FIGS. 1 and 4, the RFID tag 10 may take the form of a financial card, such as a credit card, debit card, pre-paid card, gift card, etc, or an identification card, security card, or the like. In this case, then, the RFID tag 10 may carry various information 22 printed on its front surface thereof, such as an identification of the card owner, card expiration date, card number, etc. The card/RFID tag 10 can have relatively standard dimensions for a credit card, debit card or the like, such as having, in one case, a length of about 3½″ (or less than about 4″), a width of about 2⅛″ (or less than about 3″) and a thickness of less than about ¼″, or less than about ⅛″. In addition, a magnetic strip 24 which embodies the information carried on the front of the card 10, and/or additional information, can be carried on the card 10 and is readable by a magnetic strip reader.

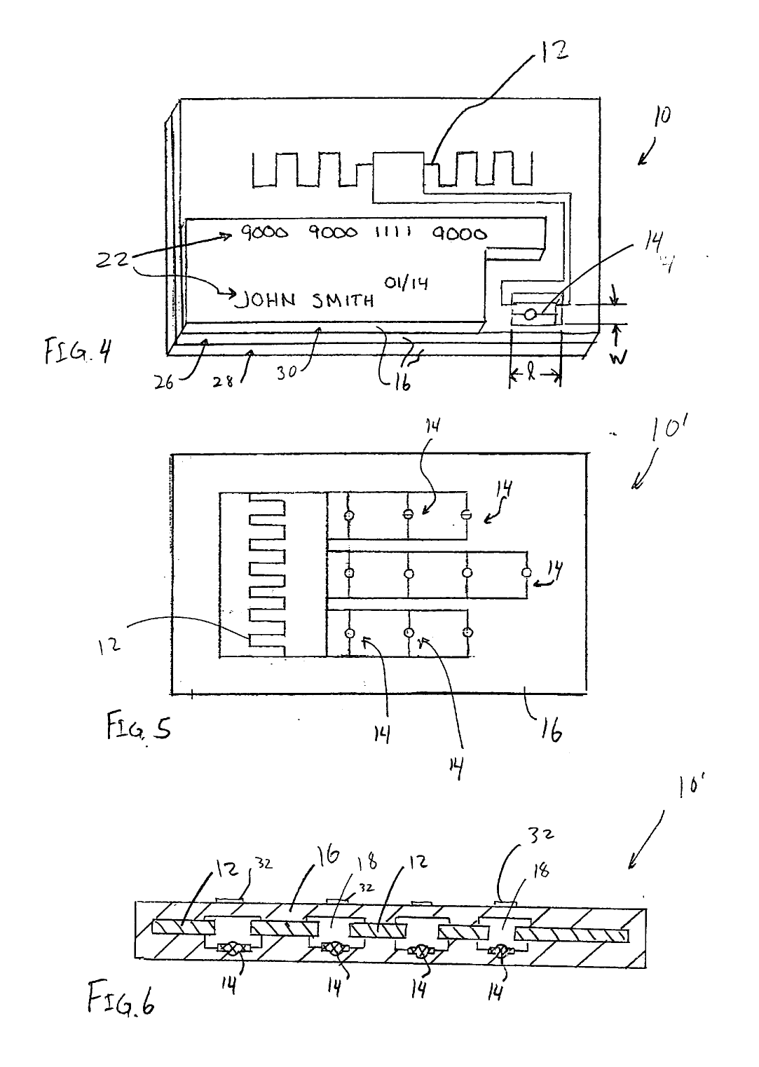

In an alternate embodiment, as shown in FIGS. 5 and 6, the tag 10′ includes an antenna 12 and a plurality of chips 14 (ten chips 14 in the illustrated embodiment). Each chip 14 can be positioned out-of-plane with the antenna 12 (or vice-versa), and be manually deflectable to place the chip 14 into (or out of) electrical connection with the antenna 12, thereby enabling (or disabling) the particular chips 14. As shown in FIG. 6, in the illustrated embodiment each chip 14 is positioned below the antenna 12, although each chip 14 can be positioned above the antenna 12, or positioned in other configurations to enable selective enablement thereof. In some cases, some chips 14 can be positioned above the antenna 12, and other positioned below the antenna 12.

In this embodiment, each chip 14 may include indicia 32 associated therewith positioned on the outer surface of the casing 12. For example, each chip 14 may include a unique numerical identifier (0-9) associated therewith. The identifiers/indicia 32 may also take the form of alphabetical symbols, alphanumeric symbols and other indicia.

Each chip 14 may include a unique identifier associated therewith such that when that chip 14 is electrically coupled to the antenna 12, the chip 14 causes the antenna 12 to broadcast an identifier or data stream for that chip 14 that is unique relative to other chips 14 on the card 10′ (or relative to any other chip 14, even on other cards/tags 10, 10′). In this manner, the tag 10′ of FIGS. 5 and 6 may be utilized by a user to transmit a stream of data to a RFID card reader, such as a pin or other security code. The tag 10′ can also be used as a security device such that, for example, a user may be required to enter a particular code before being granted access to a particular area, before a financial transaction is completed, etc.

The tag 10′/chips 14 may also be configured to transmit a particular signal when more than one of the chips 14 are enabled. For example, the chips 14 associated with the numbers “1” and “3” can be enabled at the same time, which may cause the tag 10′ to emit a signal indicating those chips 14 have been enabled. The emitted signal could, in some cases, be different than the signal associated with simply pressing “1” and “3” in order, thereby exponentially increasing the number of signals capable of being emitted due to the large number of chip combinations. This configuration also enables the use of multiple chips 14 for transmitting information in a wide variety of manners without the use of any external switches, circuitry or memory (besides that included in the chips 14) or an external power source or the like. It should be understood that, in one embodiment, the RFID tag 10, 10′ is passive and lacks any power source for storing power beyond a transient basis, such as a battery or the like.

The embodiments disclosed above show a single antenna 12 with a single chip 14, and a single antenna 12 with multiple chips 14. The RFID tag may also include multiple chips 14 with multiple antennas 12. In this case, each antenna 12 may be located in its own plane, or share a plane with other antennas 12. This embodiment provides greater flexibility as to the range of transmission and reception of data.

The tag 10, 10′ is described herein as an “RFID” tag, but it should be understood that this does not necessarily mean that the RFID tag 10, 10′/antenna 12 is restricted for use at RF frequencies. In particular, following industry convention, the RFID tag 10, 10′/antenna 12 can be utilized in conjunction with any of a wide variety of frequencies of electromagnetic energy ranging, in one case, between about 125 kHz and about 100 GHz.

Having described the invention in detail and by reference to certain embodiments, it will be apparent that modifications and variations thereof are possible without departing from the scope of the invention.

What is claimed is:

1. A RFID tag comprising:
an outer casing;
an antenna positioned in said outer casing; and
a chip positioned in said outer casing, wherein at least one of said chip or said antenna is manually movable into or out of electrical communication with the other one of said chip or antenna.

2. The tag of claim 1 wherein said at least one of said chip or antenna is biased into a position wherein said chip and antenna are not electrically coupled, and wherein said at least one of said chip or antenna is manually movable to a position wherein said chip and antenna are electrically coupled.

3. The tag of claim 2 wherein said tag is configured such that when a manual force causing said chip and antenna to be electrically coupled is removed, said at least one of said chip or antenna automatically returns to said position wherein said chip and antenna are not electrically coupled.

4. The tag of claim 2 wherein when said at least one of said chip or antenna is moved into said position wherein said chip and antenna are electrically coupled, said chip and antenna are electrically coupled at two spaced apart locations, and wherein when said chip and antenna are not electrically coupled, said chip and antennas are not electrically coupled at either of said two spaced locations.

5. The tag of claim 1 wherein said antenna is tuned to a particular frequency of electromagnetic energy, and wherein said chip is configured such that when said chip and antenna are electrically coupled and said tag is exposed to electromagnetic energy at or substantially at said particular frequency, said chip becomes electrically charged.

6. The tag of claim 5 wherein said antenna is tuned to electromagnetic energy having a frequency of between about 125 kHz and about 900 GHz.

7. The tag of claim 5 wherein said chip is configured such that, after becoming sufficiently electrically charged, said chip causes said antenna to transmit an output signal associated with said chip.

8. The tag of claim 1 wherein said antenna and said chip are both generally flat and planar, and wherein said at least one of said chip or antenna biased into a position wherein at least part of said at least one of said chip or antenna is not co-planar with the other one of said chip or antenna.

9. The tag of claim 1 wherein said casing is manually deflectable to cause said at least one of said chip or antenna to be moved into or out of electrical communication with the other one of said chip or antenna.

10. The tag of claim 1 wherein said casing is generally flat and planar, and has a length of less than about 4 inches, a width of less than about 3 inches, and a thickness of less than about ¼ inch.

11. The tag of claim 1 wherein said casing includes a magnetic strip carried on an outer surface thereof which encodes alphanumeric information.

12. The tag of claim 1 further comprising a supplemental chip positioned in said outer casing, wherein at least one of said supplemental chip or said antenna is manually movable into or out of electrical communication with the other one of said supplemental chip or said antenna.

13. The tag of claim 12 wherein said chip and said supplemental chip are each manually movable into or out of electrical communication with said antenna independently of the other, or wherein said antenna is independently manually movable into or out of electrical communication with chip and said supplemental chip.

14. The tag of claim 12 wherein said antenna is tuned to a particular frequency of electromagnetic energy, and wherein each chip is configured such that when said chip is electrically coupled to said antenna and said tag is exposed to electromagnetic energy at or substantially at said particular frequency, said chip becomes electrically charged, and wherein each chip is configured such that, after said chip is sufficiently electrically charged, said chip causes said antenna to transmit an output signal associated with said chip, and wherein each chip causes said antenna to transmit a unique signal relative to the other chip.

15. The tag of claim 1 wherein said casing defines a generally closed inner volume, and wherein said chip and said antenna are positioned in said inner volume.

16. The tag of claim 1 wherein said chip is generally flat and planar, and wherein said tag is biased to a disabled position in which said chip and antenna are not electrically coupled, wherein said at least one of said chip or antenna is manually movable to position in which said chip and antenna are electrically coupled such that said tag is in an enabled position, and wherein the distance said at least one of said chip or antenna moves to shift said tag from said enabled to said disabled position is less than a dimension of said chip with a plane of said chip.

17. A method for using a RFID tag comprising:
accessing a RFID tag having an outer casing, a chip positioned in said outer casing and an antenna positioned in said outer casing, said antenna being tuned to a particular frequency of electromagnetic energy;
manually moving at least one of said chip or antenna into electrical communication with the other one of said chip or antenna to enable said RFID tag; and
exposing said enabled tag to electromagnetic energy at or substantially at said particular frequency, thereby enabling said chip to be electrically charged and transmit an output signal via said antenna.

18. A RFID tag comprising:
an antenna; and
a generally flat, planar chip, wherein said at least one of said chip or antenna is biased to a disabled position in which said chip and antenna are not in electrical communication or an enabled position in which said chip and antenna are in electrical communication, wherein said at least one of said tag or said antenna is manually movable from said biased position to the other position, and wherein the distance said at least one of said chip or antenna moves between said positions is less than a dimension of said chip with a plane of said chip.

19. The tag of claim 18 wherein the distance said at least one of said chip or antenna moves between said positions is less than about ⅛″.

20. The tag of claim 18 further comprising a casing, and wherein said antenna and said chip are both positioned in said casing.
